(19) United States
(12) Patent Application Publication
(10) Pub. No.: US 2024/0330071 A1
(43) Pub. Date: Oct. 3, 2024

(54) AUTOMATICALLY TUNING LOGICAL PARTITION WEIGHTS

(71) Applicant: International Business Machines Corporation, Armonk, NY (US)

(72) Inventor: Brian Keith WADE, Apalachin, NY (US)

(21) Appl. No.: 18/192,199

(22) Filed: Mar. 29, 2023

(51) Int. Cl. G06F 9/50

(52) U.S. Cl. CPC G06F 9/5077; G06F 9/505

(57) ABSTRACT

Embodiments of the disclosure provide systems and methods for automatically tuning logical partition weights for logical partitions. A disclosed non-limiting system obtains observations of configuration and performance parameters for each of a plurality of logical partitions. For each of the plurality of logical partitions, tentative new weights are determined based on the configuration and performance parameters for each of a plurality of logical partitions. The tentative new weights are iteratively adjusted by a set weight increase and the set weight increase is subtracted from a weight points left variable until the weight points left variable reaches a threshold.

### BACKGROUND

The present invention relates to computer systems, and more specifically, to systems and methods for automatically tuning logical partition weights for logical partitions of a multiple processor computer system.

Logical partition weights are often used in a multiple processor computer system. A multiple processor computer system contains multiple execution contexts called logical partitions (also may be called LPARs). Logical cores of a given type of each logical partition are mapped to physical cores of the given type of the multiple processor computer system. Each logical partition includes logical partition weights used to manage the respective logical partitions. The multiple processor computer system includes a management component that dispatches logical cores of each logical partition to corresponding physical cores of the multiple processor computer system. Each logical partition has a defined configuration, for example including a number of logical cores of one or more core types, a current logical partition weight, entitlement, a minimum weight and a maximum weight for each logical core type included in a given logical partition. For example if a logical partition named FRED has cores of a first type (core type one) and cores of a second type (type two), FRED will have a current weight, entitlement, minimum weight, and maximum weight for core type one, and FRED will also have a current weight, entitlement, minimum weight, and maximum weight for core type two.

### SUMMARY

Embodiments of the present disclosure provide systems and methods for automatically tuning weights for logical partitions of a multiple processor computer system.

A disclosed non-limiting computer implemented method comprises obtaining configuration and performance parameters for each of a plurality of logical partitions. For each logical partition, the system calculates tentative new weights based on the configuration and performance parameters for each of a plurality of logical partitions. The tentative new weights of the plurality of logical partitions are iteratively adjusted by a set weight increase and the set weight increase is subtracted from a weight points left variable until the weight points left variable reaches a threshold. Final new weights are assigned to the plurality of logical partitions in response to the iterative adjustment.

Other disclosed embodiments include a computer system and computer program product for automatically tuning weights for logical partitions of a multiple processor computer system, implementing features of the above-disclosed method.

### BRIEF DESCRIPTION OF THE DRAWINGS

FIG. 1 is a block diagram of an example computer environment for use in conjunction with one or more disclosed embodiments for automatically tuning weights for logical partitions of a multiple processor computer system;

FIG. 2 is a block diagram of an example system for automatically tuning weights for logical partitions of a multiple processor computer system of one or more disclosed embodiments;

FIGS. 3A and 3B, together provide a flow chart of example operations of a method for automatically tuning weights for logical partitions of one or more disclosed embodiments; and

FIG. 4 is a flow chart of a method for automatically tuning weights for logical partitions of a multiple processor computer system of one or more disclosed embodiments.

### DETAILED DESCRIPTION

Embodiments of the disclosure automatically tune weights for logical partitions of a multiple processor computer system. In disclosed embodiments, system configuration parameters and logical partition configuration and performance parameters, for each type of core, such as the number of physical cores, the set of logical partitions, and for each such logical partition, its number of logical cores, its current weight, its minimum weight, its maximum weight, and its utilization, are obtained from observation. For each logical partition, the system calculates a logical partition entitlement, and for all the logical partitions, the system calculates a sum of logical partition weights, based on the obtained parameters. For each logical partition, the system forms a utilization ceiling projection based on a normal distribution function of utilization performance parameters for each logical partition. Tentative new weights are calculated for each logical partition based on the obtained parameters, for example including an initial or current existing weight for the logical partitions. The system identifies a best candidate of the logical partitions to receive a weight increase based on the utilization ceiling projection and logical partition entitlements for each logical partition. For example, the system can award a weight increase to a best candidate logical partition that is most under-entitled as compared to its utilization projection ceiling. The tentative new weights are adjusted for the identified best candidate logical partitions to provide optimal final adjusted weights to assign to the logical partitions to automatically tune the logical partition weights.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

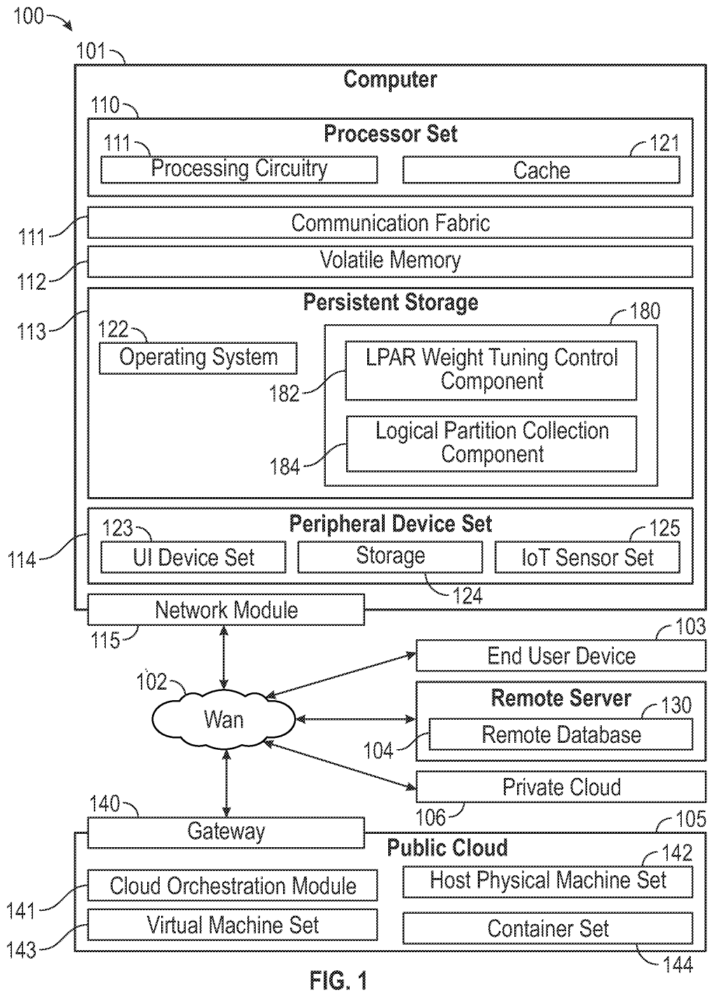

Referring to FIG. 1, a computing environment 100 contains an example of an environment for the execution of at least some of the computer code involved in performing the inventive methods, such as a Weight Tuning Control Component 182 and a Logical Partition Collection Component 184, at block 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Embodiments of the disclosure provide systems and methods for automatically tuning logical partition weights for logical partitions of a multiple processor computer system. A disclosed non-limiting computer-implemented method obtains observations of system configuration parameters and configuration and performance parameters for each of multiple logical partitions. The system obtains utilization performance parameters for each logical partition that are used to form a utilization ceiling projection for each logical partition based on a normal distribution function of the utilization performance parameters. For each logical partition, the system calculates tentative new weights based on the obtained parameters including available existing weights. The system iteratively identifies a best candidate of the logical partitions to receive a weight increase based on the utilization ceiling projection and logical partition entitlements for each logical partition. The tentative new weights are adjusted based on the identified best candidate logical partitions to provide optimal final adjusted weights assigned to the logical partitions for automatically tuning logical partition weights.

Examples components of the IBM® System Z are used for illustrative purposes in the following description. It should be understood that the disclosed embodiments are not limited by the illustrative examples; the disclosed embodiments can be used with various computer systems.

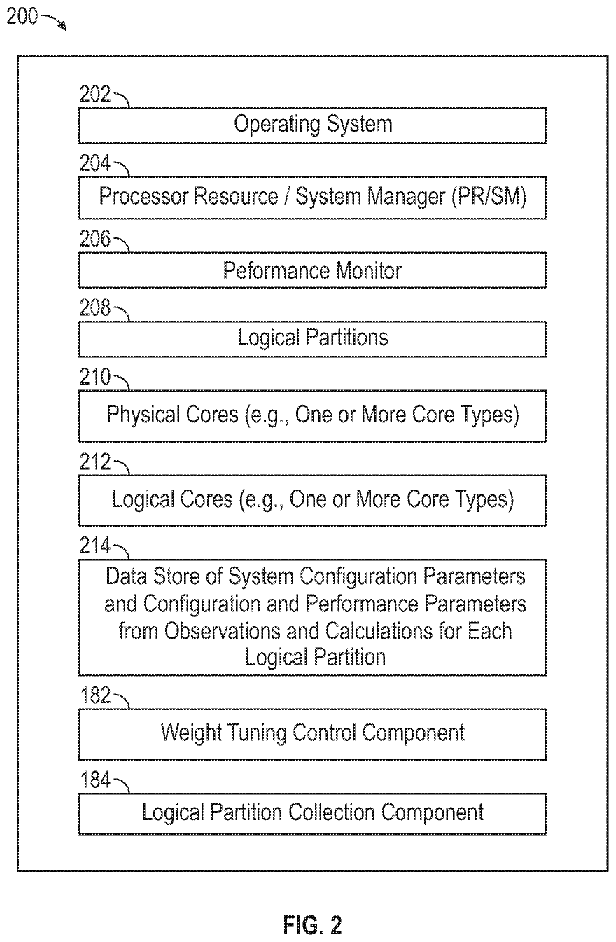

FIG. 2 illustrates an example system 200 for automatically tuning logical partitions weights for logical partitions of a multiple processor computer system of one or more disclosed embodiments. System 200 can be used in conjunction with the computer 101 and cloud environment of the computing environment 100 of FIG. 1 for implementing enhanced logical partition weights of one or more disclosed embodiments.

System 200 includes the Weight Tuning Control Component 182 and the Logical Partition Collection Component 184 of FIG. 1 used with the computer 101 for implementing methods of disclosed embodiments. In one embodiment, system 200 uses the Weight Tuning Control Component 182 to control operations of disclosed methods for tuning logical partitions weights. In one embodiment, system 200 uses the Logical Partition Collection Component 184 to access system configuration parameters and logical partition configuration and performance parameters.

System 200 includes an Operating System 202, such as an Operating System z/VM of an IBM® System Z (e.g., Mainframe). System 200 includes an available logical partition system manager, such as Processor Resource/System Manager (PR/SM) 204, and a Performance Monitor 206 for monitoring logical partition parameter and performance parameters of a plurality of logical partitions 208. System 200 can include a plurality of physical cores 210 of one or more core types, a plurality of logical cores 212 of one or more core types, and a data store 214 used for storing system configuration parameters, and parameters and performance observations and calculated parameters for each logical partition 208. For example, the data store 214 stores a number of physical cores 210 of each type defining the system configuration parameters. In one embodiment, the data store 214 can store parameters and performance observations and performance calculations for each logical partition 208 comprising one or more at least one of a number of logical cores of each type, current weight, current utilization and historical utilizations, a calculated utilization ceiling projection, current entitlement, or an entitlement limit or cap. In one embodiment, the data store 214 optionally stores for each logical partition 208, a partition type of eligible, or not eligible, for weight management, and for eligible logical partition types, a minimum weight and a maximum weight can be stored for each eligible logical partition 208.

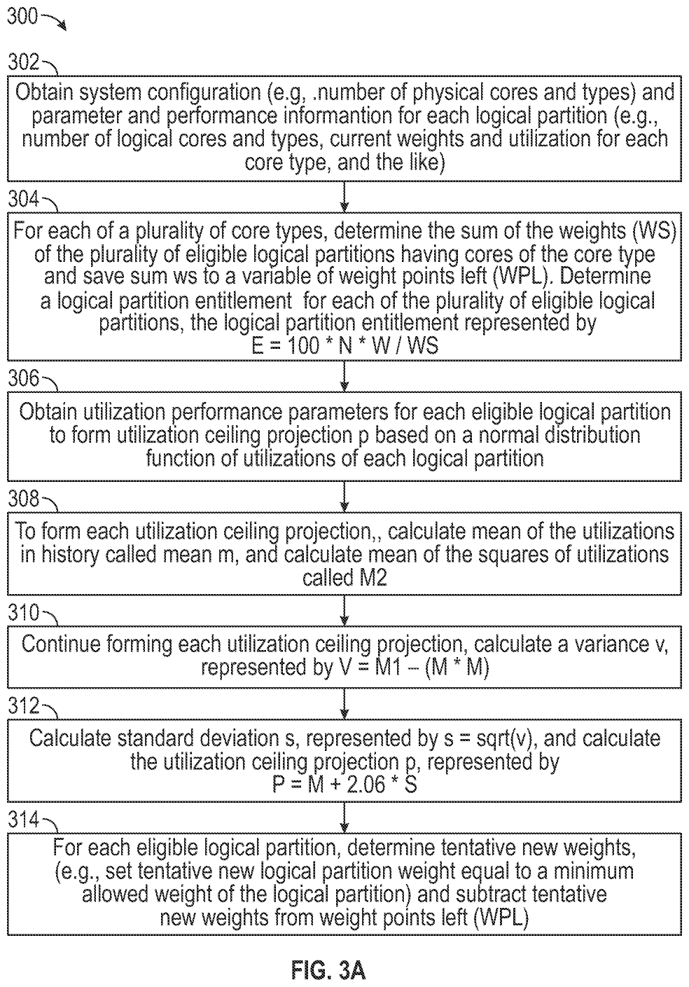

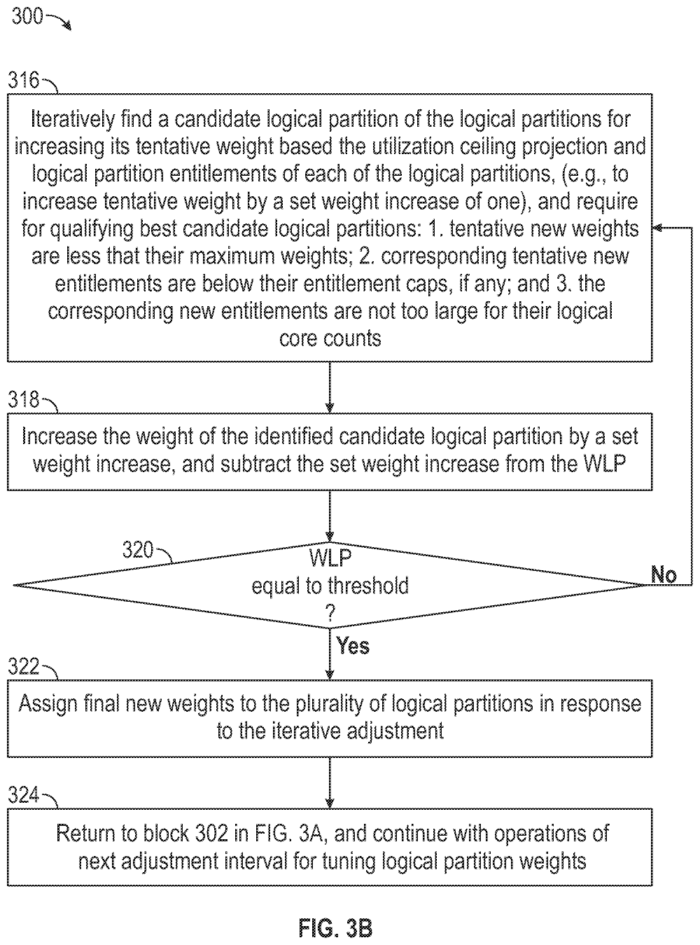

FIGS. 3A and 3B together illustrate example operations of a method 300 for implementing automatically tuning logical partitions weights for logical partitions of one or more disclosed embodiments. For example, method 300 can be implemented by system 200 in conjunction with the computer 101 of FIG. 1 with the Weight Tuning Control Component 182 and the Logical Partition Collection Component 184.

As shown in FIG. 3A, operations of the logical partition weight tuning method 300 start at block 302. At block 302, system 200 can access the data store 214 to obtain system configuration parameters and configuration and performance parameters for each of the logical partitions 208. The system configuration parameters can include a number of physical cores and a number of logical partitions. The configuration and performance parameters can include for example available logical core weights, logical core counts, and core utilizations or consumptions for each logical core of each given core type for the logical partitions 208.

In one embodiment, system 200 can store system configuration parameters, and logical partition configuration and performance parameters obtained from observations and calculated parameters for each logical partition in the data store 214. System 200 can periodically access the PR/SM 204 and Performance Monitor 206 to obtain available configuration and performance parameters for the logical partition 208 (e.g., system 200 can access the PR/SM 204 and Performance Monitor 206 once each weight adjustment interval, such as once each minute).

For example, in one embodiment system 200 stores in data store 214 configuration parameter values that are specified by system analysts for each logical partition 208, such as the number of logical cores 212 of each type, and an initial weight for each core type of the logical cores 212 present in the logical partition 208. In one embodiment, system 200 stores in data store 214 other parameter values specified by system analysts such as whether the logical partition's type is eligible type for weight management or ineligible type to indicate that the weights of the ineligible logical partition should not be changed. For logical partitions eligible for weight management, system 200 can store in data store 214 specified minimum and maximum weights for each core of its logical core types. In one embodiment, system 200 stores updated configuration choices when specified by system analysts. System 200 uses selected system and logical partition configuration and performance parameters for programmatic operations of automated methods according to disclosed embodiments to automatically tune logical partition weights of the logical partitions 208.

At block 304, system 200, for each of a plurality of core types, determines and saves a sum of the weights, (e.g., calculated Weight Sum called WS), for the plurality of the eligible logical partitions 208 having cores of the core type, using the selected configuration and performance parameters obtained at block 302. At block 304, system 200 saves the sum of the weights WS to a variable, Weight Points Left (WSL). At block 304, system 200 determines a logical partition entitlement E for each of the plurality of eligible logical partitions 208. The obtained logical partition individual weights typically change in method operations to calculate tentative new weights, while the calculated sum of Weight Sum WS is not changed. The logical partition entitlements E for each logical partition 208 can be represented by E=100*N*W/WS, where N is the number of physical cores of the type, W is a logical partition's weight, and WS is a Weight Sum of all the logical partitions.

At block 306, system 200 obtains utilization performance parameters for each of the plurality of logical partitions to form a utilization ceiling projection P for each of the plurality of logical partitions based on a normal distribution function of the utilization performance parameters. At block 308, to form each utilization ceiling projections, system 200 calculates the mean of the utilizations called Mean M and second calculating the mean of the squares of the utilizations called M2. At block 310, continuing to form each utilization ceiling projection, system 200 calculates a variance V equal to the mean of the squares of the utilizations M2 less the square of the Means M, with V represented by:

$$V = M 2 - ( M * M ) .$$

At block 312, system 200 calculates a standard deviation S and a utilization ceiling projection P. For example, S represented by:

S=sqrt(V), where sqrt( ) is the square-root function

System 200 calculates the utilization ceiling projection P is represented by:

$$P = M + 2.06 * S .$$

The standard deviation S is multiplied by coefficient 2.06, which comes from the properties of a normal distribution of utilizations. Due to the properties of the normal distribution, the next utilization value to be collected is 95% likely to be less than or equal to the calculated utilization ceiling projection P.

At block 314, system 200 determines tentative new weights for each of the plurality of eligible logical partition 208, and subtracts the tentative new weights from the variable Weight Points Left (WSL) for the eligible logical partitions. For example, system 200 can assign a tentative new weight equal to a minimum allowed weight of a given logical partition 208, and subtracts the tentative new weights from the variable WSL. In this way, once all eligible logical partitions 208 have been assigned a tentative new weight, the Weight Points Left WPL has been decreased by the sum of all the tentative new weights at block 314.

Referring to FIG. 3B method 300 continues starting at block 316, system 200 can iteratively find a candidate of the logical partitions 208 for increasing its tentative weight based on the utilization ceiling projection and logical partition entitlements for each of the plurality of logical partitions. System 200 can require for qualifying candidate logical partitions 208: first, whose tentative new weights are less than their maximum weights; second, whose corresponding tentative new entitlements are below their entitlement caps, if any; and third, whose corresponding tentative new entitlements are not too large for their logical core counts. At block 316, system 200 further can limit the qualifying candidate for increasing its tentative weight by identifying the qualifying logical partitions 208 whose tentative new entitlement is a smallest percentage of its utilization projection ceiling P. In other words, from among the eligible logical partitions 208 that qualify based on the above factors for increasing its tentative new weight by a set weight increase, such as by 1, system 200 can award the one-point weight increase to the logical partition 208 that is most under-entitled as compared to its utilization projection ceiling P.

System 200 can iteratively identify one of logical partitions 208 as the candidate logical partition at block 316. At block 318, system 200 increases the weight of the identified candidate logical partition 208 by a set weight increase, such as one, and the set weight increase is subtracted from WPL. At decision block 320, system 200 checks if WLP has reached a threshold, such as zero. Operations return to block 316 when WLP is not equal to the threshold and operations continue as before until WPL reaches the threshold. When the threshold for WPL is identified at decision block 320, system 200 assigns final new weights to the plurality of the logical partitions in response to the iterative adjustment, to provide optimal weights for the logical partitions at block 322. At block 324, system 200 returns to block 302 in FIG. 3A and continues with above described operations of a next adjustment interval for tuning logical partition weights.

A simulated program implemented the example of the method 300 and provided an example problem and solution as follows. The simulated example includes a physical computer having 12 physical cores of a first type. A first logical partition of two logical partitions includes 6 logical cores of the first type, current weight of 15, current entitlement of 180, no entitlement cap, eligible type for weight management, a minimum weight of 1 and a maximum weight of 30, a utilization ceiling projection of 434, a new weight of 30 and a new entitlement of 360 with set of utilizations of 425, 415, and 428. A second logical partition includes 5 logical cores of the first type, current weight of 85, current entitlement of 1020, no entitlement cap, eligible type for weight management, a minimum weight of 1 and a maximum weight of 99, a utilization ceiling projection of 358, a new weight of 70 and a new entitlement of 840 with set of utilizations of 325, 285, and 235.

The first logical partition has a utilization ceiling projection of 434 well above its current entitlement of 180, so to increase its entitlement, some weight is moved to the first logical partition to increase its entitlement. As described above, the current weight of the first logical partition the first logical partition is increased from 15 to 30. The second logical partition has a utilization ceiling projection of 358 well below its current entitlement of 1020. The second logical partition serves as a donor with its current weight decreased from 85 to 70, as described above.

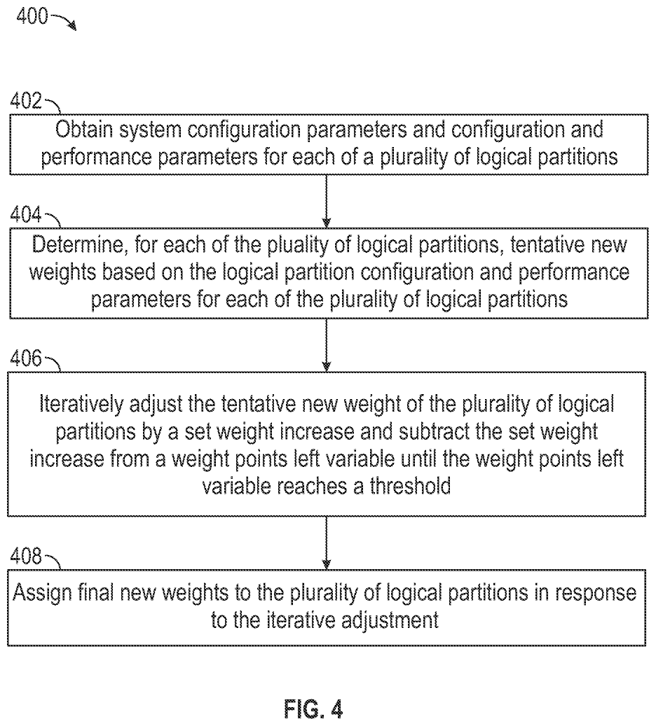

FIG. 4 illustrates a method 400 for automatically tuning weights for logical partitions of a multiple processor computer system of one or more disclosed embodiments. At block 402, system 200 obtains configuration and performance parameters for each of a plurality of logical partitions. System 200 uses selected parameters to implement methods for automatically tuning of logical partition weights according to disclosed embodiments. For example, in a disclosed embodiment, system configuration parameters comprise a number (e.g., 16) of physical cores 210 of a given core type, and a number (e.g., 4) of logical partitions 208. For example, in a disclosed embodiment, the logical partition configuration parameter and performance parameters for each logical partition comprise a number of logical cores 212 of each core type, an available initial and current weights and core utilizations of each core 212 of each core type. The core utilizations can include a current core utilization and a selected number or set of historical core utilizations for each logical core types of each logical partition 208.

At block 404, system 200 determines, for each of the plurality of logical partitions, tentative new weights based on the logical partition configuration and performance parameters, for example including an initial weight and existing weights. At block 406, system 200 iteratively adjusts the tentative new weights of the plurality of logical partitions by a set weight increase and subtracts the set weight increase from a weight points left variable until the weight points left variable reaches a threshold.

At block 408, system 200 assigns final new weights to the plurality of logical partitions in response to the iterative adjustment. In brief, the final new weights provide optimal weights assigned to the plurality of logical partitions of the disclosed embodiments. The optimal new weights are provided in proportion to the utilization ceiling projections of the plurality of logical partitions. Each of the optimal new weights assigned to the plurality of logical partitions are less than a maximum allowed weight for the logical partitions. Each of the optimal new weights assigned to the plurality of logical partitions are less than an entitlement cap of the logical partitions. Further, none of the assigned new weights of the logical partitions provides an entitlement beyond an entitlement limit that the logical partitions are capable of using.

While the foregoing is directed to embodiments of the present invention, other and further embodiments of the invention may be devised without departing from the basic scope thereof, and the scope thereof is determined by the claims that follow.

What is claimed is:

1. A method comprising:
obtaining configuration and performance parameters for each of a plurality of logical partitions;
determining, for each of the plurality of logical partitions, tentative new weights based on the configuration and performance parameters for each of a plurality of logical partitions;
iteratively adjusting the tentative new weights of the plurality of logical partitions by a set weight increase and subtracting the set weight increase from a weight points left variable until the weight points left variable reaches a threshold; and
assigning final new weights to the plurality of the logical partitions in response to the iterative adjustment.

2. The method of claim 1, wherein the configuration and performance parameters for each of a plurality of logical partitions comprise observations of at least one of logical core weights, logical core counts, or core utilizations for each logical core of a given type.

3. The method of claim 1, further comprises determining a sum of logical partition weights for the plurality of logical partitions based on the configuration and performance parameters for each of a plurality of logical partitions and saving the sum of logical partition weights to the weight points left variable.

4. The method of claim 1, further comprises obtaining system configuration parameters and determining, for each of the plurality of logical partitions, a logical partition entitlement based on the logical partition weights and the system configuration parameters.

5. The method of claim 4, wherein the logical partition entitlement for each of the plurality of logical partitions logical partitions is represented by E=100*N*W/WS, where N is the number of physical cores of the type, W is a logical partition's weight, and WS is a Weight Sum of all the logical partitions.

6. The method of claim 1, further comprises obtaining utilization performance parameters for each of the plurality of logical partitions to form a utilization ceiling projection for each of the plurality of logical partitions based on a normal distribution function of the utilization performance parameters.

7. The method of claim 6, wherein obtaining utilization performance parameters for each logical partition to form the utilization ceiling projection further comprises calculating a mean M of the utilization performance parameters and calculating the mean of the squares M2 of the utilization performance parameters.

8. The method of claim 7, further comprises calculating a variance V equal to the mean of the squares M2 of the utilization performance parameters less the square of means M, the variance V is represented by V=M2−(M*M).

9. The method of claim 8, further comprises calculating a standard deviation S represented by S=sqrt(V), where sqrt( ) is the square-root function, and calculating the utilization ceiling projection P represented by P=M+2.06*S.

10. The method of claim 1, further comprises identifying a candidate of the plurality of logical partitions to receive the set weight increase based on a utilization ceiling projection and a logical partition entitlement for each of the plurality of logical partitions.

11. A system, comprising:
a processor; and
a memory, wherein the memory includes a computer program product configured to perform operations for automatically tuning logical partition weights for logical partitions of a multiple processor computer system, the operations comprising:
obtaining configuration and performance parameters for each of a plurality of logical partitions;
determining, for each of the plurality of logical partitions, tentative new weights based on the configuration and performance parameters for each of a plurality of logical partitions;
iteratively adjusting the tentative new weights of the plurality of logical partitions by a set weight increase and subtracting the set weight increase from a weight points left variable until the weight points left variable reaches a threshold; and
assigning final new weights to the plurality of the logical partitions in response to the iterative adjustment.

12. The system of claim 11, wherein the configuration and performance parameters for each of a plurality of logical partitions comprise observations of at least one of logical core weights, logical core counts, or core utilizations for each logical core of a given type.

13. The system of claim 11, further comprises determining a sum of logical partition weights for the plurality of logical partitions based on the configuration and performance parameters for each of a plurality of logical partitions and saving the sum of logical partition weights to the weight points left variable.

14. The system of claim 11, further comprises obtaining system configuration parameters and determining, for each of the plurality of logical partitions, a logical partition entitlement based on the logical partition weights and the system configuration parameters.

15. The system of claim 11, further comprises obtaining utilization performance parameters for each of the plurality of logical partitions to form a utilization ceiling projection for each of the plurality of logical partitions based on a normal distribution function of the utilization performance parameters.

16. A computer program product for automatically tuning logical partition weights for logical partitions of a multiple processor computer system, the computer program product comprising:
a computer-readable storage medium having computer-readable program code embodied therewith, the computer-readable program code executable by one or more computer processors to perform an operation comprising:
obtaining configuration and performance parameters for each of a plurality of logical partitions;
determining, for each of the plurality of logical partitions, tentative new weights based on the configuration and performance parameters for each of a plurality of logical partitions;
iteratively adjusting the tentative new weights of the plurality of logical partitions by a set weight increase and subtracting the set weight increase from a weight points left variable until the weight points left variable reaches a threshold; and
assigning final new weights to the plurality of the logical partitions in response to the iterative adjustment.

17. The computer program product of claim 16, wherein the configuration and performance parameters for each of a plurality of logical partitions comprise observations of at least one of logical core weights, logical core counts, or core utilizations for each logical core of a given type.

18. The computer program product of claim 16, further comprises obtaining utilization performance parameters for each of a plurality of logical partitions to form a utilization ceiling projection for each of a plurality of logical partitions based on a normal distribution function of the utilization performance parameters.

19. The computer program product of claim 16, further comprises obtaining system configuration parameters and determining, for each of the plurality of logical partitions, a logical partition entitlement based on the logical partition weights and the system configuration parameters.

20. The computer program product of claim 16, further comprises determining a sum of logical partition weights for the plurality of logical partitions based on the configuration and performance parameters for each of a plurality of logical partitions and saving the sum of logical partition weights to the weight points left variable.
